(19) United States
(12) Patent Application Publication
(10) Pub. No.: US 2014/0162882 A1
(43) Pub. Date: Jun. 12, 2014

(54) CABLE TERMINATION FOR HIGH VOLTAGE POWER CABLES COOLED BY A GASEOUS CRYOGEN

(71) Applicant: The Florida State University Research Foundation, Inc., Tallahassee, FL (US)

(72) Inventors: Lukas Graber, Tallahassee, FL (US); Horatio Rodrigo, Tallahassee, FL (US); Danny G. Crook, Tallahassee, FL (US); Sastry Pamidi, Tallahassee, FL (US); Steinar Dale, Tallahassee, FL (US); Bianca Trociewitz, Crawfordville, FL (US)

(73) Assignee: The Florida State University Research Foundation, Inc., Tallahassee, FL (US)

(21) Appl. No.: 13/890,816

(22) Filed: May 9, 2013

Related U.S. Application Data
(60) Provisional application No. 61/645,304, filed on May 10, 2012.
(60) Provisional application No. 61/697,567, filed on Sep. 6, 2012.

(51) Int. Cl. H01B 12/16

(52) U.S. Cl. CPC H01B 12/16
USPC 505/163; 174/73.1

(57) ABSTRACT

A cable termination utilizing liquid and gaseous cryogen. The liquid cryogen maintains cryogen temperatures of all dielectric surfaces exposed to gaseous cryogen and to high voltage potential. The invention further includes capacitive grading, minimizing the electric field on the surface of the bushing in the vapor phase of the cryogen used in the liquid cryogen compartment. The cross-section of the conductor within the cable termination is adjusted along its axis enabling thermal optimization for reduction in the loss of liquid cryogen. Heat sink, for helium gas cooling of superconducting power devices, is surrounded by a metal of high thermal conductivity and placed near the area needed to be cooled. Cryogenic gaseous coolant flows through two tubes connected to the heat sink. Fins inside heat sink increase metal surface in contact with the coolant. The coolant flows from first tube, passes through the finned are and exits through the second tube.

### CROSS-REFERENCE TO RELATED APPLICATIONS

This nonprovisional application is a continuation of and claims priority to provisional application No. 61/645,304, entitled “Cable Termination for High Voltage Power Cables Cooled by a Gaseous Cryogen”, filed May 10, 2012 and provisional application No. 61/697,567, entitled “Cryogenic Heat Sink for Helium Gas Cooled Superconducting Power Devices”, filed Sep. 6, 2012 by the same inventors.

### BACKGROUND OF THE INVENTION

1. Field of the Invention

This invention relates, generally, to high voltage power cables. More particularly, it relates to terminations used in high voltage power cables and methods of maintaining temperatures and integrities thereof. This invention also related to cooling high temperature superconducting power devices. More particularly, it relates to a cryogenic cooling system for high temperature superconductor (HTS) devices.

2. Description of the Prior Art

A high voltage cable termination has the purpose to allow an electric connection of a cable with connectors, conductors, or bus bars. The termination must allow dielectric integrity and thermal management of a cable at any point of operation, in particular for any permissible load current and ambient temperature, when cooled by a gaseous cryogen.

Dielectric integrity is challenging in systems with gaseous cryogen used as both coolant and electric insulation. Gaseous media have a low dielectric strength compared to liquid media. However, gaseous media is considerably better at cryogenic temperature and elevated pressure compared to standard temperature and pressure (“STP”) conditions. The importance that any gaseous cryogen at the cable termination is at low temperature and high pressure, particularly on the solid insulator surfaces, is paramount.

Careful thermal management is critical in order to keep the conductor in the cable cold (i.e., minimize heat influx to cable) and at the same time minimize the required power to cool termination and the cable. Thermal management is interconnected with dielectric integrity since the temperature of the gaseous cryogen is critical for dielectric integrity.

Accordingly, what is needed is an apparatus and method for more efficiently maintaining temperature and dielectric integrity in cable terminations. However, in view of the art considered as a whole at the time the present invention was made, it was not obvious to those of ordinary skill how the art could be advanced.

Superconducting power devices, such as cables, fault current limiters or transformers, need feedthroughs that connect them with other elements of the power system that stay at ambient temperature. The components at ambient temperature cause a substantial heat influx to the superconducting device. It needs to be ensured that the superconducting device remains at the designed operating cryogenic temperature.

Currently, the standard method of cooling for high temperature superconducting power devices is to use liquid nitrogen in the temperature range of 68-77 L. Yet this method is far from perfect. There have been various attempts to improve upon this method of superconducting cooling. U.S. Pat. No. 6,854,276 B1 to Yuan et al., discloses a method and apparatus of cryogenic cooling for high temperature superconductor devices. Yuan pressurizes liquid cryogen to above atmospheric pressure to improve its dielectric strength, while sub-cooling the liquid cryogen to below its saturation temperature. This method allows for cooling of high-voltage HTS materials without degrading the dielectric strength of liquid nitrogen. Despite the proposed advantages associated with the Yuan system there are several disadvantages. First, the system fails to provide a very compact apparatus. Second, the apparatus lacks simple manufacturing and low manufacturing costs. Finally, this apparatus lacks maximum heat transfer/high efficiency coefficient.

Another method of cooling high temperature superconducting material is disclosed in U.S. Pat. No. 7,748,102 B2 to Manousiouthakis et al. Manousiouthakis provides an apparatus where HTS wire is surrounded by an inner layer of thermal insulator, such as copper, and an outer layer of thermal insulator with cryogenic coolant sources distributed along the power transmission cable. The result is a compact apparatus for cooling HTS devices. However, this apparatus lacks a maximum heat transfer/high efficiency coefficient.

One of the greatest disadvantages of the prior art is the use of liquid cryogens. Liquid cryogens poses potential unacceptable asphyxiation hazards as well as high pressure hazards associated with phase change. These disadvantages are described in “High temperature superconducting degaussing from feasibility study to fleet adoption,” by Kephart et al., herein incorporated by reference. However; using only gaseous helium makes the cable more sensitive to heat influx because the heat capacity of helium gas is inferior to that of liquid nitrogen.

There exists a need for an effective apparatus and method for reducing temperatures of HTS devices without the use of liquid cryogens. Additionally, there exists a need for a compact, vacuum tight apparatus for cooling HTS devices with maximum heat transfer/high efficiency coefficient. This can be achieved through implementation of a heat sink to intercept the heat leak from the room temperature components to the superconducting cable. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for an improved, more effective and more efficient cable termination is now met by a new, useful and nonobvious invention.

The current invention described a novel cable termination combining gaseous and liquid cryogens. The introduction of a liquid cryogen ensures that all dielectric surfaces exposed to the gaseous cryogen as well as parts on high voltage potential are held at cryogenic temperatures. The introduction of capacitive grading minimizes the electric field on the surface of the bushing in the vapor phase of the cryogen used in the liquid cryogen compartment. The change of cross-section of the conductor along its axis enables the thermal optimization for reduction in the loss of liquid cryogen.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the nature and objects of the invention, reference should be made to the following detailed disclosure, taken in connection with the accompanying drawings, in which:

FIG. 1 depicts an embodiment of a cable termination;

FIG. 2 depicts a close-up view of an optimized field grading in a gaseous nitrogen section a cable termination;

FIG. 3 depicts a close-up view of a conductor with variable cross-section as a function of expected temperature;

FIG. 4 depicts thermal field in steady state of a top feedthrough and part of a cryostat at 3000 A continuous load current, 293 K ambient temperature, and 77 K liquid cryogen temperature;

FIG. 5 depicts thermal field in steady state of a bottom feedthrough at 3000 A continuous load current, 77 K liquid cryogen temperature, and 50 K gaseous helium temperature;

FIG. 6 depicts electrostatic field around a flange of a top feedthrough at 10 kV conductor voltage;

FIG. 7 depicts electrostatic field around the end of a grading layer in a top feedthrough at 10 kV conductor voltage;

FIG. 8 depicts electrostatic field of an upper part of a bottom feedthrough at 10 kV conductor voltage;

FIG. 9 depicts electrostatic field of a lower part of a bottom feedthrough at 10 kV conductor voltage;

FIG. 10. is a schematic diagram of the cable termination with heat sink, HTS cable, and copper conductor for the larger embodiment of the present invention.

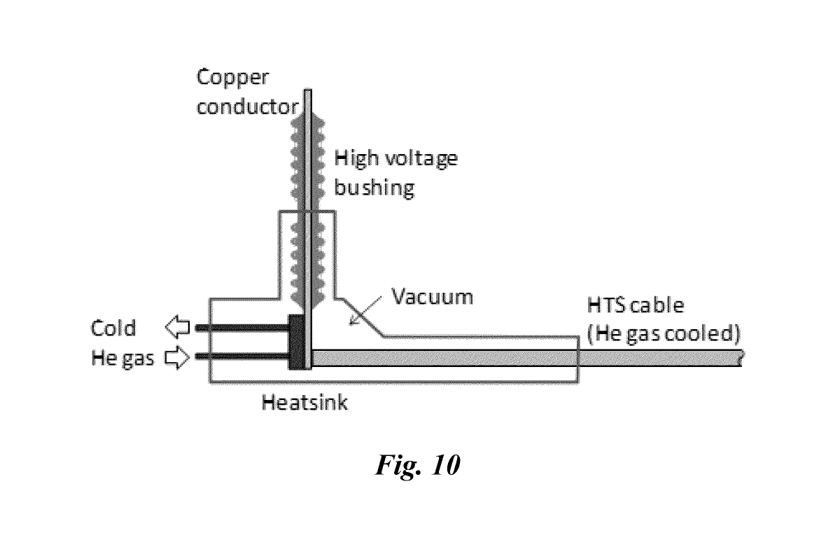

FIG. 11 is an illustration of a larger embodiment of the heat sink

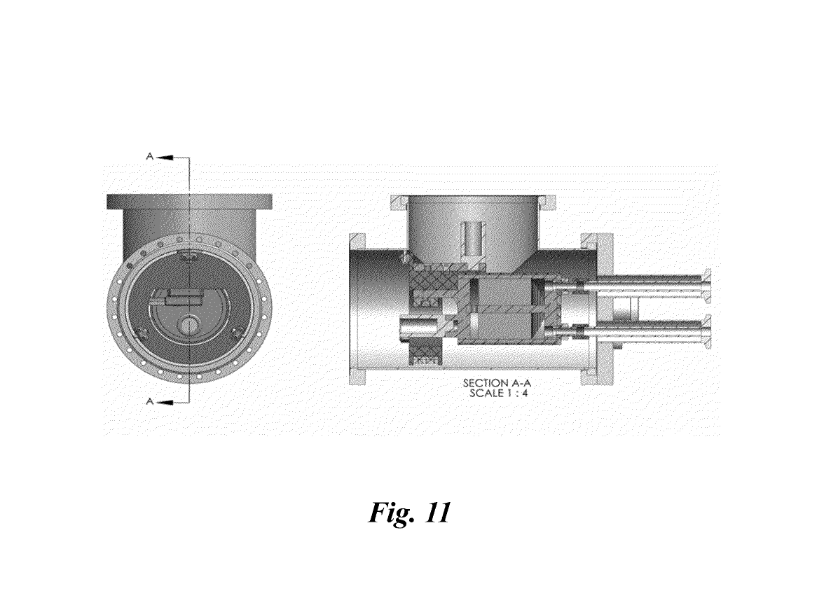

FIG. 12 is an illustration of the smaller heat sink with a total view and a cut view to show the internal fin structure.

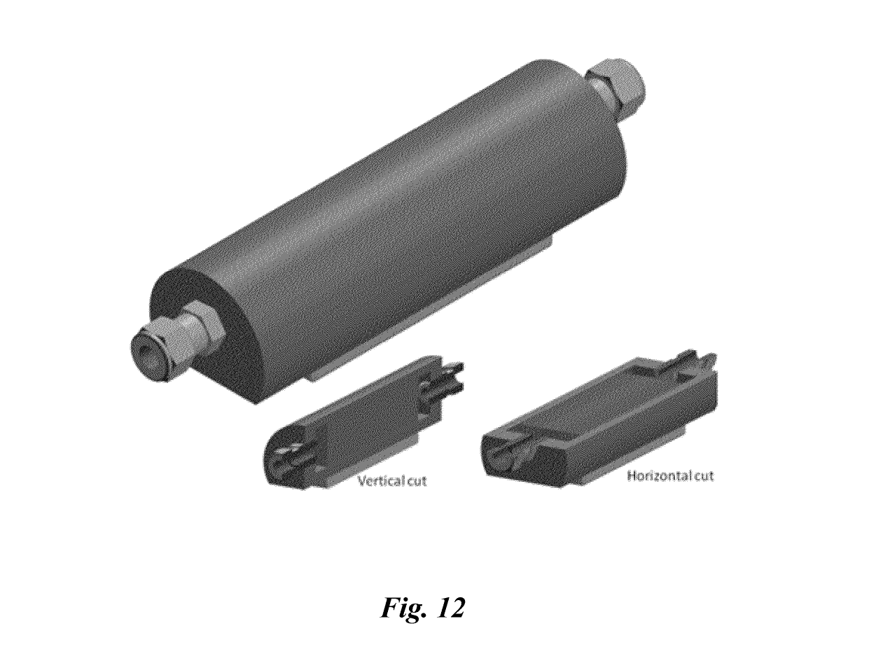

FIG. 13 is an illustration of surface temperature of the heat sink along with the velocity field of the coolant flow for the smaller embodiment of the present invention.

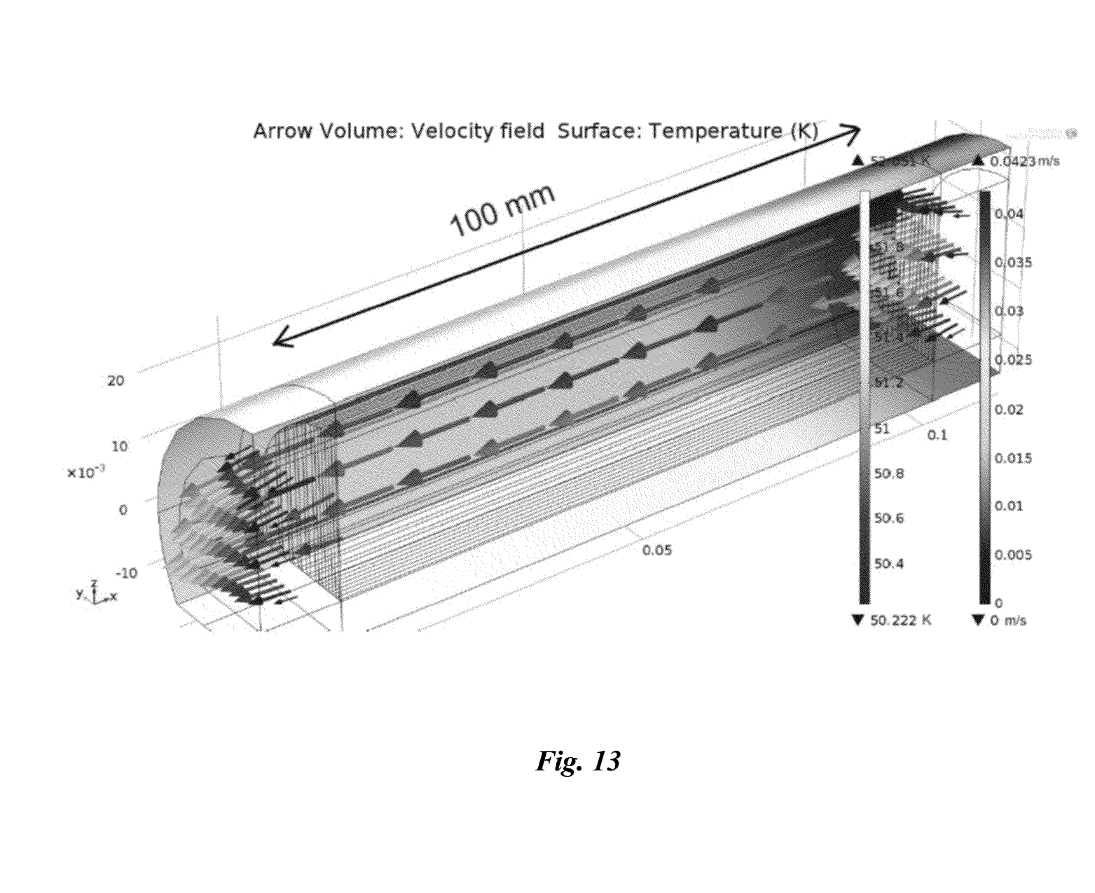

FIG. 14 is an illustration of the smaller heat sink before brazing the parts together.

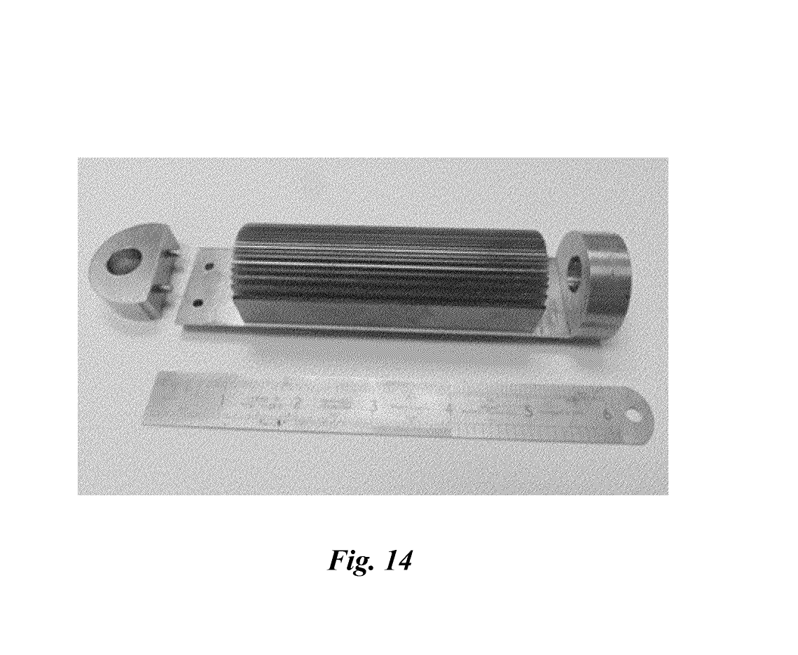

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

Certain embodiments of the current invention describe a solution for maintaining both dielectric and thermal integrity by introducing a liquid cryogen. The liquid cryogen has dielectric strength substantially higher than the gaseous cryogen used in the cable, in part due to the higher density of the liquid cryogen. At the same time, the liquid cryogen features increase heat conduction, which facilitates keeping all parts at cryogenic temperature that are at high voltage and in contact with the gaseous cryogen. For example, an example of a suitable combination of cryogens is liquid nitrogen and high-pressure gaseous helium, the latter being the gaseous cryogen in the cable.

### EXAMPLE 1

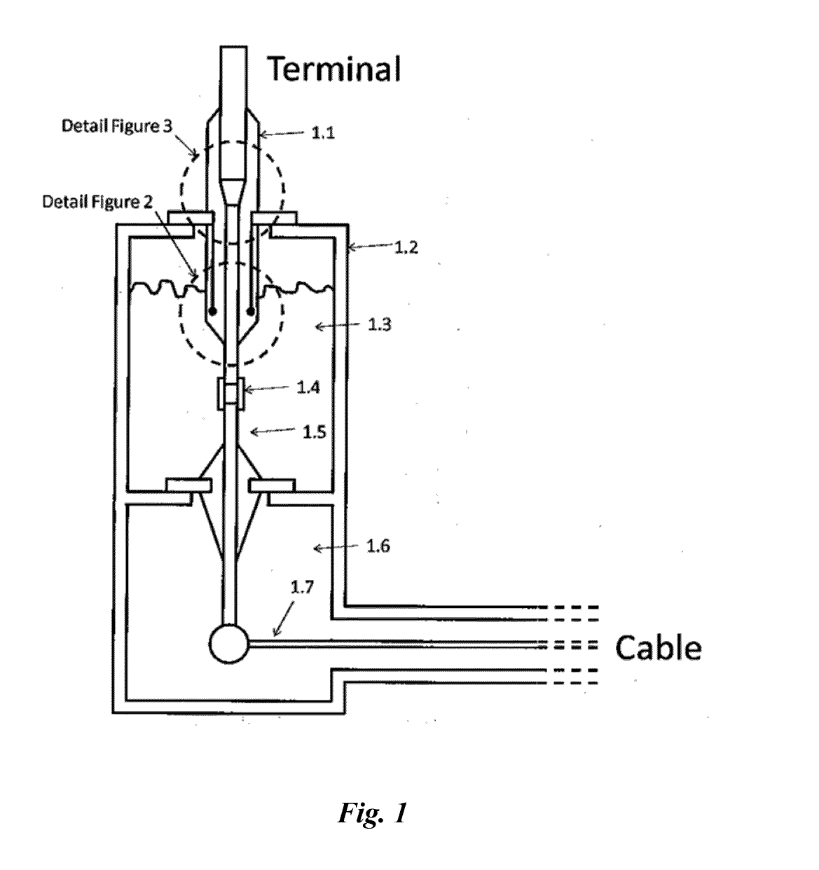

As depicted in FIG. 1, the upper bushing (1.1) extends into the upper chamber of the cryostat (1.2). This chamber is filled with a liquid cryogen (1.3). It is electrically connected to the lower bushing (1.5) by a flexible joint (1.4). The flexible joint (1.4) reduces the mechanical stress due to different coefficients of thermal expansion of the materials used. The lower chamber of the cryostat (1.2) contains the superconducting cable (1.7). It is pressurized with a high pressure gaseous cryogen (1.6) at cryogenic temperature. This particular arrangement with the liquid nitrogen chamber allows a cold surface of the lower bushing on the side of the gaseous cryogen. This is a crucial requirement for the dielectric properties of the cable termination. A single bushing spanning from ambient directly into the gaseous cryogen chamber of the cryostat would not guarantee a cold surface of the insulator inside the gaseous cryogen. The reduced heat load to the gaseous cryogen chamber is an additional benefit.

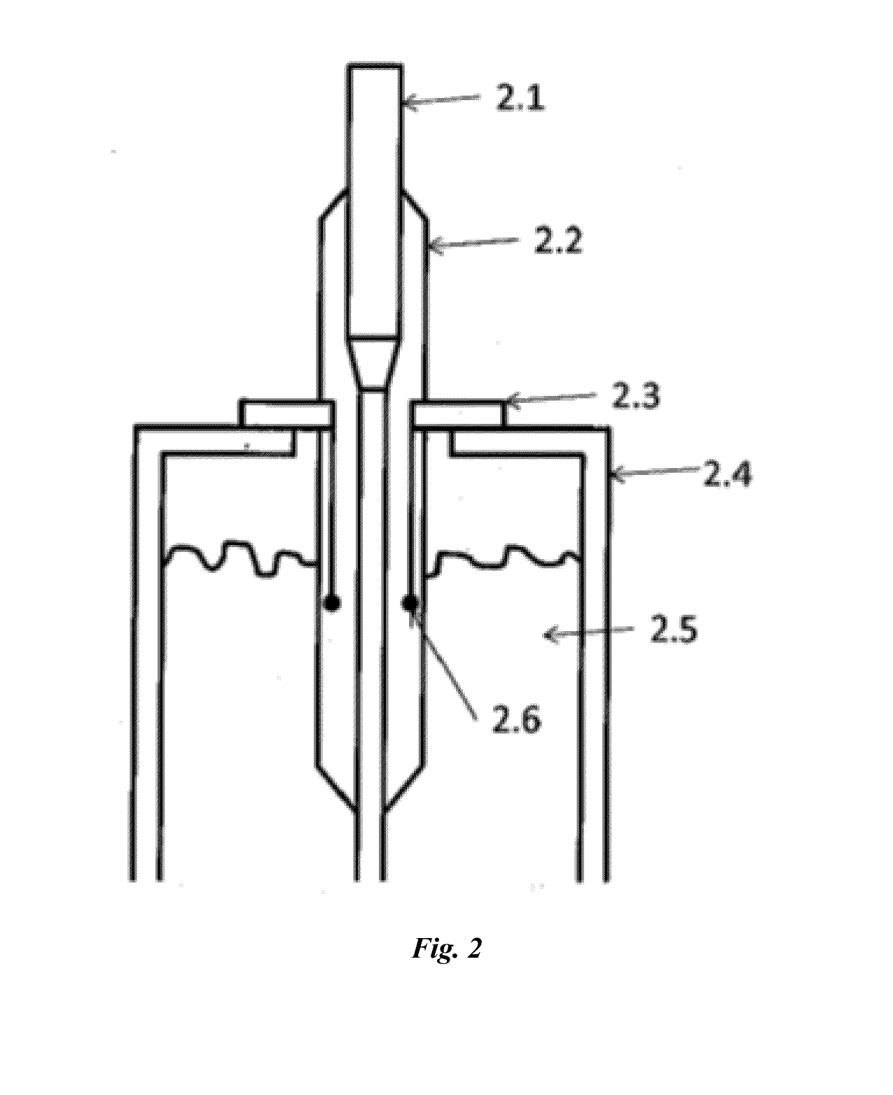

As depicted in FIG. 2, the insulator body (2.2) is fixed to the cryostat by a flange (2.3). Since the dielectric strength of the cryogen is higher when it is in liquid phase as opposed to gaseous phase, the area above the fluid level should be kept free of any electric field. The internal field grading structure (2.6) in the insulator body is made of conductive material and is grounded via connection to the flange. The metal structure must be long enough to extend below the liquid level of the cryogen. This reduces the electric field to a negligible level on the surface of the insulator exposed to the vapor phase of the cryogenic liquid.

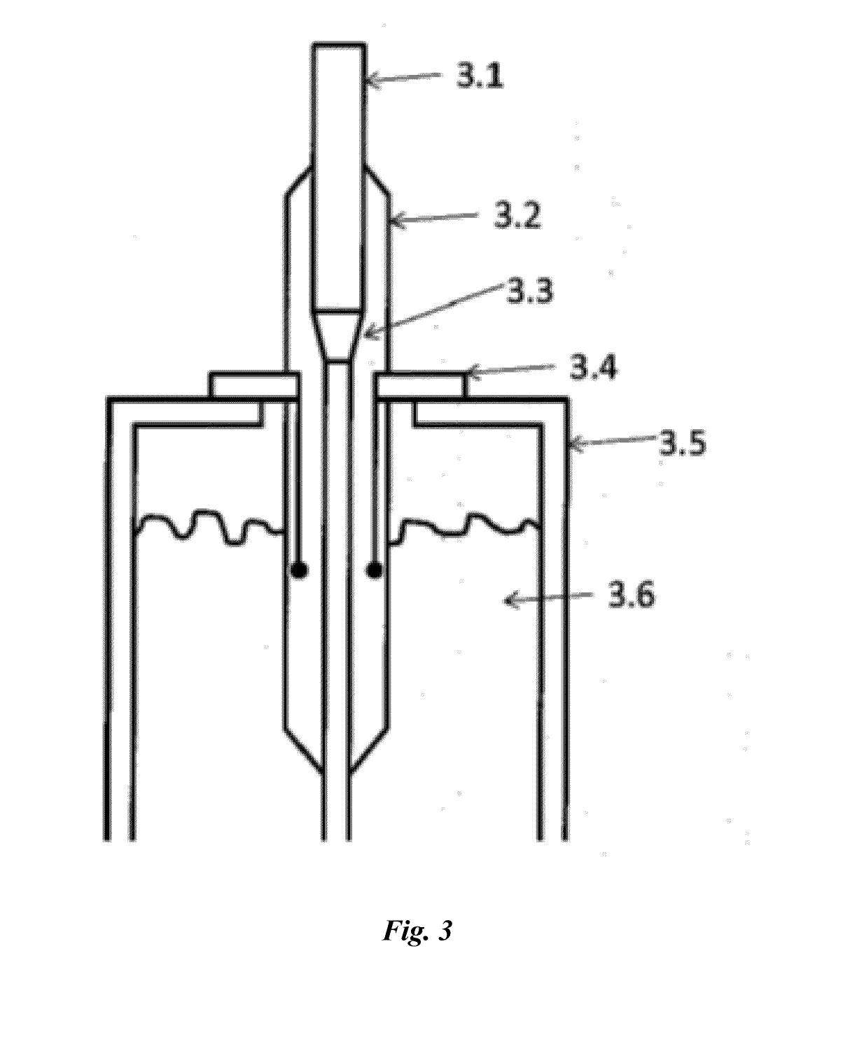

As depicted in FIG. 3, in order to reduce the boil-off of the liquid cryogen, the heat influx from ambient, as well as the ohmic losses in the conductors (3.1) of the bushings, must be minimized. This requires a small cross-section to minimize the heat influx from ambient and at the same time a large cross-section to reduce the ohmic losses. The electric conductivity of the metallic conductor is substantially higher in the lower region than in the upper region since its temperature is lower. Therefore, the optimal solution is to have a smaller cross-section in the lower region and a larger cross-section in the upper region. The optimum transition region (3.3) was found to be on the upper side just above the flange (3.4).

### EXAMPLE 2

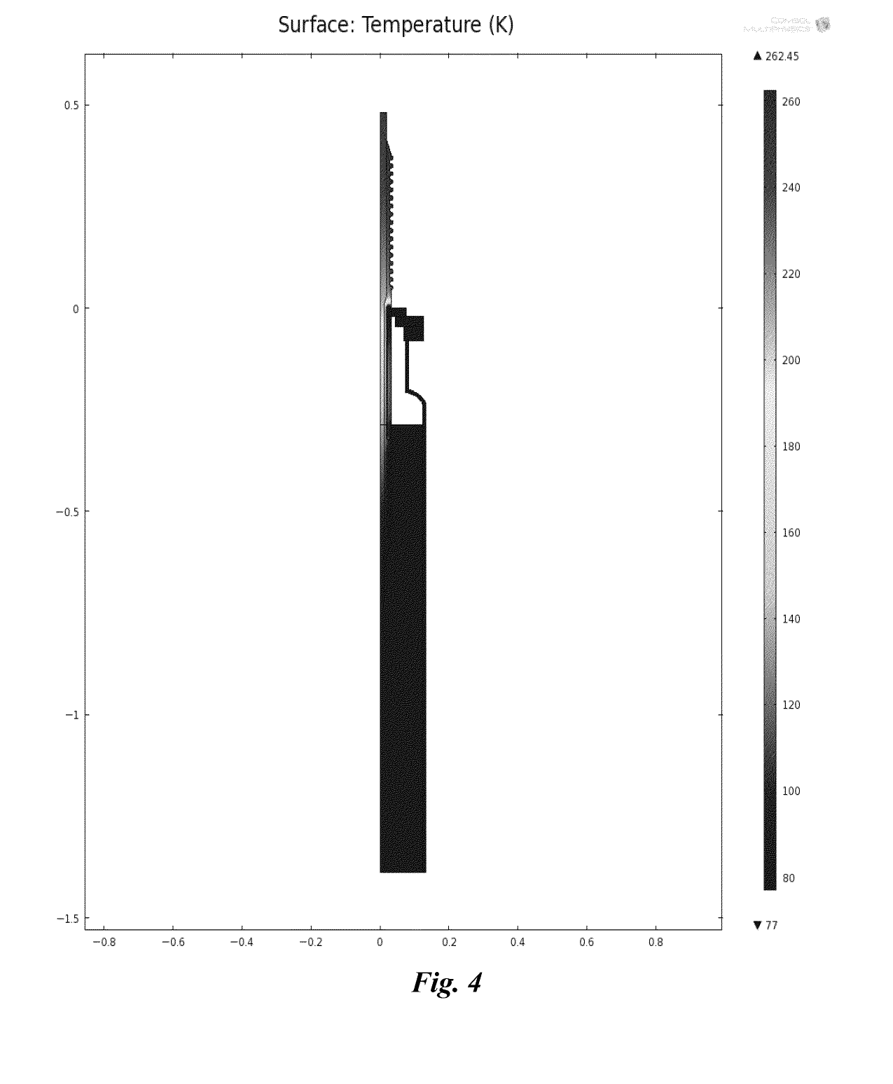

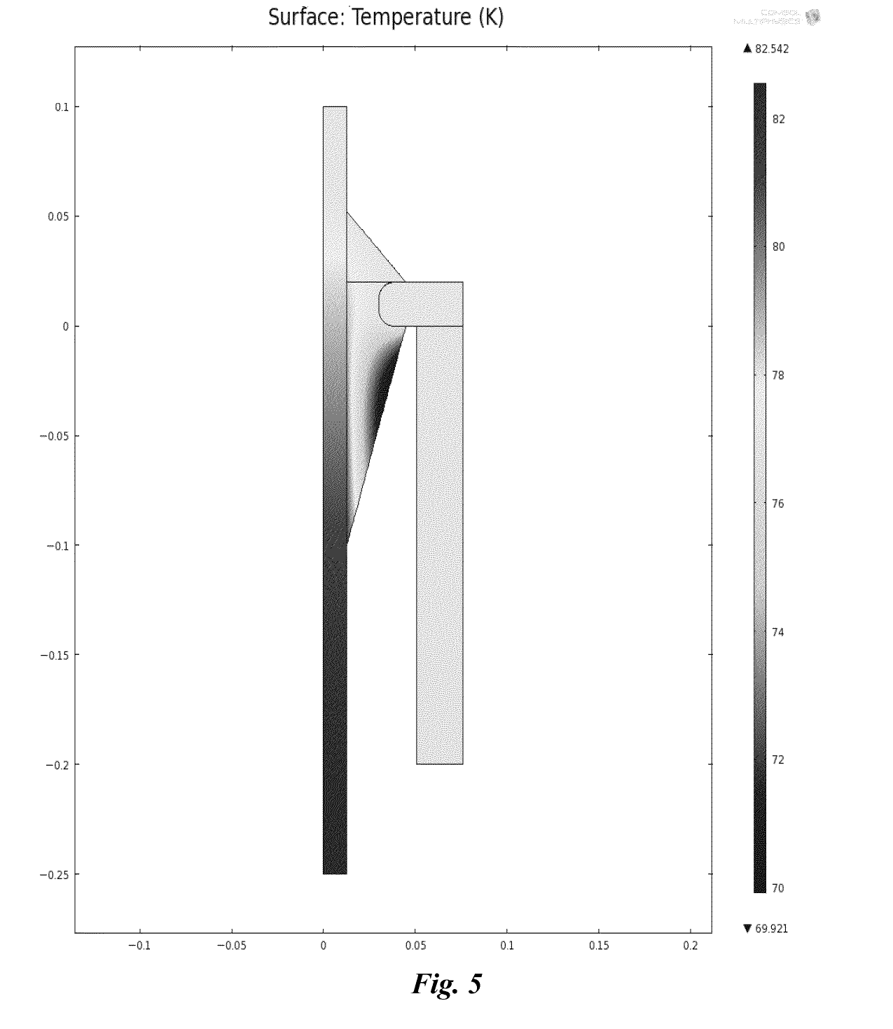

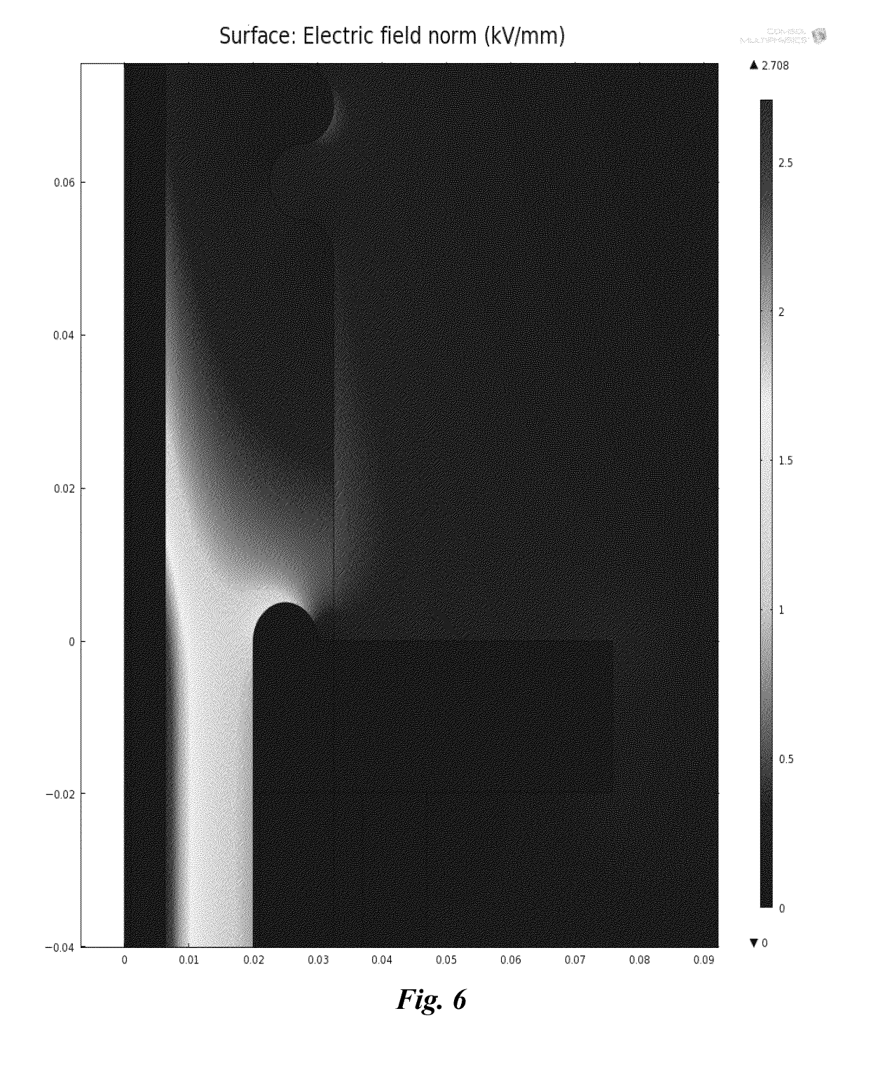

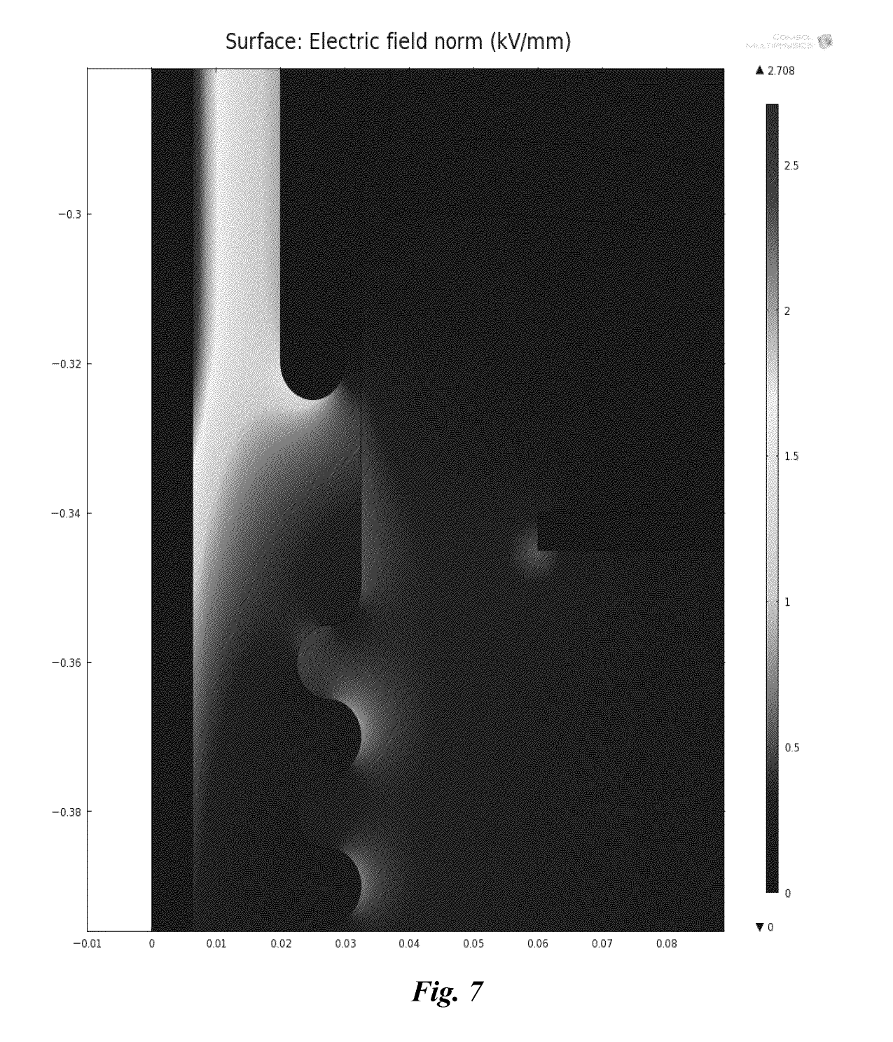

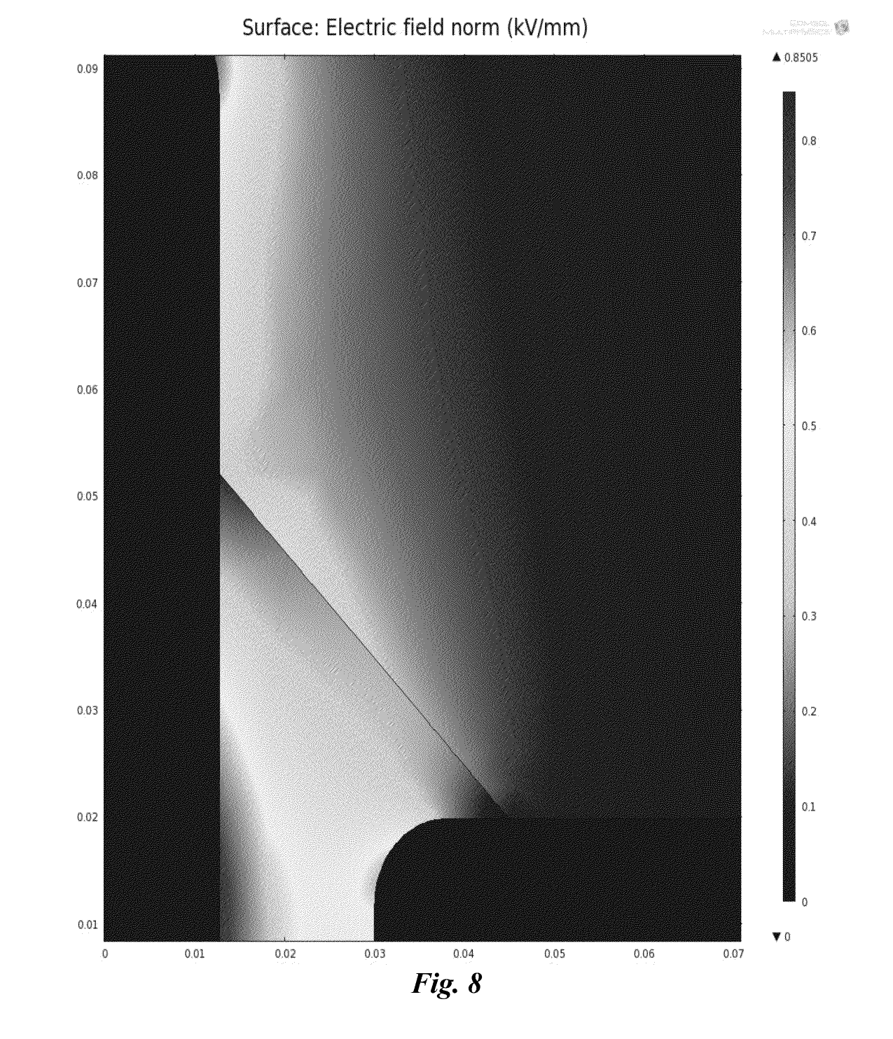

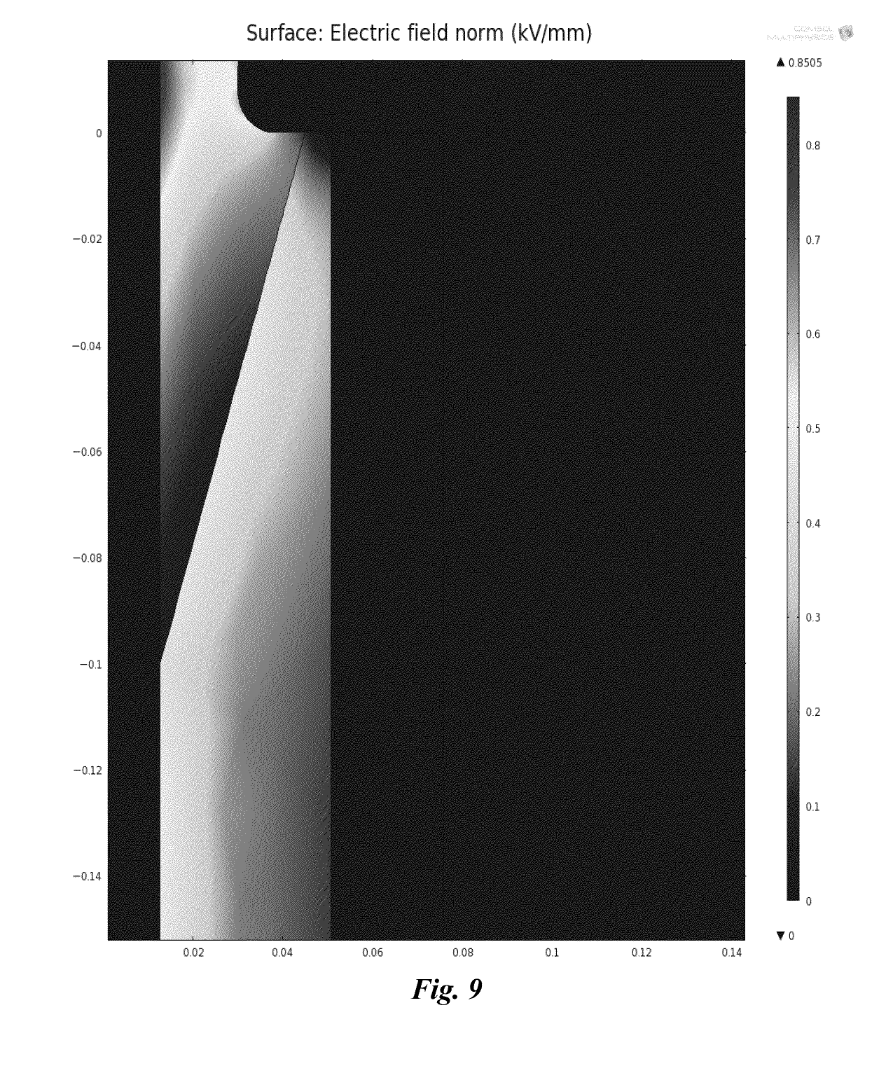

As depicted in FIGS. 4-9, the thermal field of a model case was simulated using a finite element software package. The thermal field is shown for the top feedthrough including part of the liquid cryogen tank in FIG. 4. The thermal field is shown for the bottom feedthrough in FIG. 5. The electrostatic field around the flange and the grading layer of the top feedthrough is shown in FIGS. 6 and 7, respectively. The electrostatic field of the upper part and the lower part of the bottom feedthrough is shown in FIGS. 8 and 9, respectively.

The entire heat sink consists of a metal of high thermal conductivity, e.g. copper. It features a flat surface where it attaches to the location that needs to be cooled, i.e. the location where the superconductor and the copper conductor are connected together. Two tubes are fixed to the heat sink. One of it acts as the inlet and the other as the outlet for the cryogenic gaseous coolant. The coolant enters through the first tube, passes through the finned area inside the heat sink and exits through the second tube. Inside the hollow heat sink are fins to increase metal surface in contact with the coolant. The surface area must be high to ensure optimal heat transfer from the metallic surface to the coolant. The fins are spaced in a manner to optimize heat transfer. At the same time the pressure drop of the coolant needs to be minimized. The chosen geometry with two sets of non-uniformly spaced straight fins achieves sufficient heat transfer while keeping the pressure drop low. The geometry is also optimized to allow machining by conventional mechanical methods and/or electric discharge machining

FIG. 1 is an illustration of a larger embodiment of the present invention. The heat sink is made of copper and features 18 fins of 10 cm length. It is integrated in a cylindrical copper tube, flattened on the bottom side. Cryogenic helium gas is injected at high pressure by an external helium circulation system. An external helium circulation system is substantially disclosed in “Cryogenic helium gas circulation system for advanced characterization of superconducting cables and other devices,” by Kephart et al., herein incorporated by reference. The input temperature and pressure at the heat sink are fixed at 50 K and 1.82 MPa, respectively. Heat sink and connections are enclosed in a vacuum chamber to reduce the heat transfer from the ambient.

FIG. 2 is a schematic diagram of the larger heat sink. The HTS cable is inserted through a first end and connects to a copper conductor and high voltage brushing. Copper conductor and high voltage brushing lay perpendicular and in contact with the HTS cable. Copper conductor and high voltage brushing exit vertically through a top end of the heat sink. Helium gas is pumped through and exits through two tubes located on a second end opposite the first end. Centered in the diagram is a vacuum chamber to reduce heat transfer from the ambient.

FIG. 3 is a close up of another embodiment of the heat sink. The heat sink consists of four parts: The base block with fins, two end plates, and the tube surrounding the other parts. All parts except for the cuts between the fins were machined mechanically. The cuts were machined by electrical discharge machining (EDM). It is noted that different manufacturing methods may be employed. The four parts were joined by silver braze for maximum conductivity and excellent structural strength. The supply tubes were soldered into the holes in the end plates using tin-lead solder. A heater wire was attached to the bottom plate by epoxy resin. The type of resin (Stycast 2850FT) was chosen for its high thermal conductivity, achieved by a high content of aluminum oxide filler. A temperature sensor was also embedded for recording and experimental purposes.

The heat sink was then wrapped in a couple of layers of aluminized Mylar (multi-layer insulation, MLI) and installed in the vacuum chamber. Two additional temperature sensors were attached to the tube to measure the inflow and outflow temperatures. An adjustable DC voltage source was used to control the heat influx to the heat sink. The helium circulation system allows pressure and temperature of the helium inflow. A differential pressure gauge was used to measure the pressure drop in the heat sink for informational and experimental purposes.

It will thus be seen that the objects set forth above, and those made apparent from the foregoing disclosure, are efficiently attained. Since certain changes may be made in the above construction without departing from the scope of the invention, it is intended that all matters contained in the foregoing disclosure or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A cable termination to maintain and test dielectric and thermal integrity at cryogenic temperatures in high voltage power cables, comprising:
a cryostat having a chamber with an upper portion and a lower portion;
an upper brushing extending into said upper portion of said chamber of said cryostat;
liquid cryogen disposed within said upper portion of said chamber of said cryostat;
a lower brushing extending into said lower portion of said chamber of said cryostat, said lower brushing in electrical connection with said upper brushing via a flexible a flexible joint that reduces mechanical stress due to different coefficients of thermal expansion of materials used in said cable termination;
a superconducting cable disposed within said lower portion of said chamber of said cryostat; and
gaseous cryogen disposed within said lower portion of said chamber of said cryostat,
whereby said liquid cryogen has a higher density than said gaseous cryogen, thus increasing heat conduction, in turn maintaining cryogenic temperature for all parts at high voltage and in contact with said gaseous cryogen.

2. A cable termination as in claim 1, further comprising:
an insulator body affixed in overlying relation to said cryostat by a flange;
an internal field grading structure that is disposed within said insulator body, formed of conductive material, and grounded via connection to said flange, said internal field grading structure having a length sufficient to extend into said liquid cryogen,
whereby the area above said liquid cryogen within said chamber of said cryostat can be kept substantially free of any electric field, thereby minimizing electric field level on said insulator body exposed to the vapor phase of said cryogenic liquid.

3. A cable termination as in claim 2, further comprising:
a conductor extending through the longitudinal extent of said insulator body, said conductor having an upper region above said flange and a lower region below said flange,
said upper region of said conductor having a larger cross section to minimize ohmic losses in said conductor, and
said lower region of said conductor having a smaller cross section to minimize heat influx from ambient,
whereby the minimization of ohmic losses and heat influx reduces boil-off of said liquid cryogen.
